(19) United States
(12) Patent Application Publication
(10) Pub. No.: US 2014/0000738 A1
(43) Pub. Date: Jan. 2, 2014

(54) EASY LINKING TRANSFER SYSTEM

(71) Applicants: David L. Reynolds, Bromont (CA); Daniel MacDonald, Bromont (CA); Yan Tremblay, Orford (CA); Eric Geoffroy, Ayer's Cliff (CA)

(72) Inventors: David L. Reynolds, Bromont (CA); Daniel MacDonald, Bromont (CA); Yan Tremblay, Orford (CA); Eric Geoffroy, Ayer's Cliff (CA)

(21) Appl. No.: 13/261,729

(22) PCT Filed: Mar. 5, 2012
(86) PCT No.: PCT/CA12/00190

§ 371 Date: Aug. 30, 2013

(30) Foreign Application Priority Data
Mar. 4, 2011 (CA) 2,733,446
Jul. 6, 2011 (CA) 2,746,031

(51) Int. Cl. A61J 1/20

(52) U.S. Cl. CPC A61J 1/20
USPC 137/798

(57) ABSTRACT

A transfer device for pharmaceuticals comprising a housing which has an open bottom permitting insertion of a vial within the housing, a piercing member mounted within the housing and having an interior passageway formed therein, a connector for a syringe located on top of the housing, and a moveable member mounted within the housing, the moveable member being moveable from a first position preventing access to the piercing member and a second position permitting access to the piercing member when the vial is inserted in the housing.

### FIELD OF THE INVENTION

The present invention relates to a transfer system and more particularly, relates to an assembly for transferring one or more components of a pharmaceutical composition between containers.

### BACKGROUND OF THE INVENTION

Typically, a syringe is, filled manually by aspirating a liquid pharmaceutical component from a pharmaceutical vial which traditionally has a penetrable closure. The syringe has a needle that penetrates the penetrable closure following which the syringe is typically filled by drawing air into the body of the syringe, aligning the needle with the vial's penetrable closure and inserting the needle through the penetrable closure into the vial. Subsequently, the vial is inverted and air is forced from the body of the syringe into the vial. The plunger is then withdrawn to draw out the desired volume of the pharmaceutical component into the syringe and the needle is removed from the vial.

Many pharmaceutical preparations must be distributed and sold as two or more separate components—typically a solid component and a liquid component. They are mixed just prior to administration. In some instances, the two or more components may each be liquid and require mixing prior to administration to the patient.

### SUMMARY OF THE INVENTION

It is an object of the present invention to provide an assembly for transferring the contents of a first container to a second container.

According to one aspect of the present invention, there is provided a transfer device comprising a housing having a top, a side wall, an open bottom, the open bottom permitting insertion of a vial within the housing, a piercing member mounted within the housing, the piercing member having a piercing tip located at a bottom end thereof, the piercing member having an interior passageway formed therein, a connector located on an exterior side of the top, a moveable member mounted within the housing, the moveable member being moveable from a first position wherein the moveable member prevents access to the piercing tip and a second position permitting access to the piercing tip when the vial is inserted in the housing.

In a large number of cases, the transfer device of the present invention provides for the easy linking of a vial and a syringe whereby the components may be mixed to form a composition in the syringe ready for patient injection.

The contents of the vial may be any suitable pharmaceutical component though in many instances, it will be a dry pharmaceutical component such as a lyophilized product. However, as previously mentioned, it could also be a liquid component.

The syringe will normally contain a liquid component which is frequently a diluent for the active pharmaceutical ingredient in the vial. The syringe may be any conventional syringe readily available from different manufacturers. Typically, the syringe will contain a piston and have a back stop or finger flange attached to one end thereof. A plunger rod will be attachable to the piston of the syringe.

One problem with known transfer devices is that access to the needle or plastic spike within the transfer device should be minimized to prevent accidental pricks. Once such transfer device is shown in International Application PCT/CA2010/001399, the teachings of which are incorporated herein by reference. In the transfer device, a cap is provided to permit access to the syringe side of the device and the luer connection cannot be accessed until the cap is removed. However, the cap can only be removed when the device is coupled to the vial.

On some occasions, it is deemed desirable to re-use the transfer device. With the aforementioned transfer device, this was not possible as the vial remains secured to the transfer device and both are disposed of as a unit.

On other occasions, it is deemed best practise to not permit re-use of the transfer device due to possible contamination. However, it is still desirable to protect the user from the needle or spike.

In one embodiment of the present invention wherein the device may not be re-used, the moveable member engages the wall of the housing upon upward movement when the vial is inserted into the housing. The rotational movement moves it to an upper position which, when the vial is pulled down, the moveable member moves to a position where it still protects against accidental needle prick but also cannot be moved upwardly again as it is locked position.

In a further embodiment, the moveable member is retracted down to a position from which it started to enable re-use of the transfer device.

### BRIEF DESCRIPTION OF THE DRAWINGS

Having thus generally described the invention, reference will be made to the accompanying drawings illustrating an embodiment thereof, in which:

FIG. 1 is a side elevational view of a transfer device according to the present invention;

FIG. 2 is a side elevational view, partially in section, of a vial containing a medicant;

FIG. 3 is a side elevational view of a syringe and plunger rod;

FIG. 4 is a cross sectional view of the transfer device prior to its use;

FIG. 5 is a side sectional view of the device being placed on a vial;

FIG. 6 is a side sectional view showing piercing of the vial;

FIG. 7 is a cross sectional view illustrating the cap being removed;

FIG. 8 is a view, partially in cross section, of a syringe being attached to the transfer device;

FIG. 9 is a cross sectional view illustrating a syringe being ready to be placed on the vial;

FIG. 10 is a cross sectional view illustrating the syringe attached to the vial;

FIG. 11 is a sectional view illustrating the mixing of components;

FIG. 12 is a sectional view illustrating the aspiration of the mixture into the syringe

FIG. 13 is a cross sectional view illustrating placement of the transfer assembly on a vial;

FIG. 14 is an exploded view illustrating the transfer assembly and the vial prior to insertion of the vial;

FIG. 15A is a bottom perspective view of a transfer assembly according to one embodiment of the present invention;

FIG. 15B is a bottom plan view thereof;

FIG. 16A is a perspective view of the transfer assembly according to a further embodiment;

FIG. 16B is a bottom plan view thereof;

FIG. 17A is an exploded view of the transfer assembly;

FIG. 17B is a bottom perspective view thereof;

FIGS. 17C to 17E show the sequence of placing the transfer assembly on the vial;

FIGS. 17F to 17H illustrate the placement of the transfer assembly in a further embodiment thereof on a vial;

FIG. 18 is an exploded view of the transfer assembly; and

FIGS. 19A to 19D are perspective views illustrating placement of the transfer assembly on a vial and removal thereof.

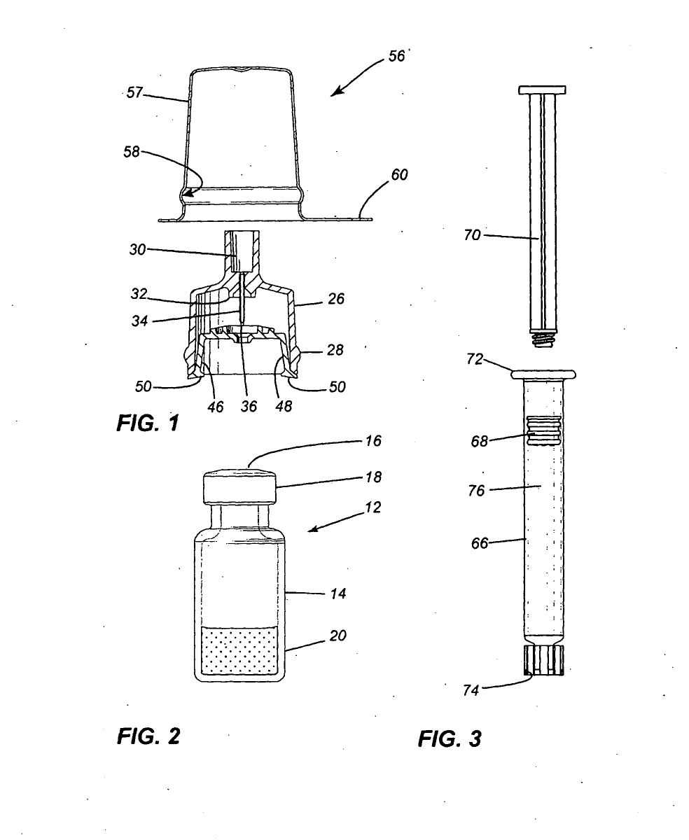

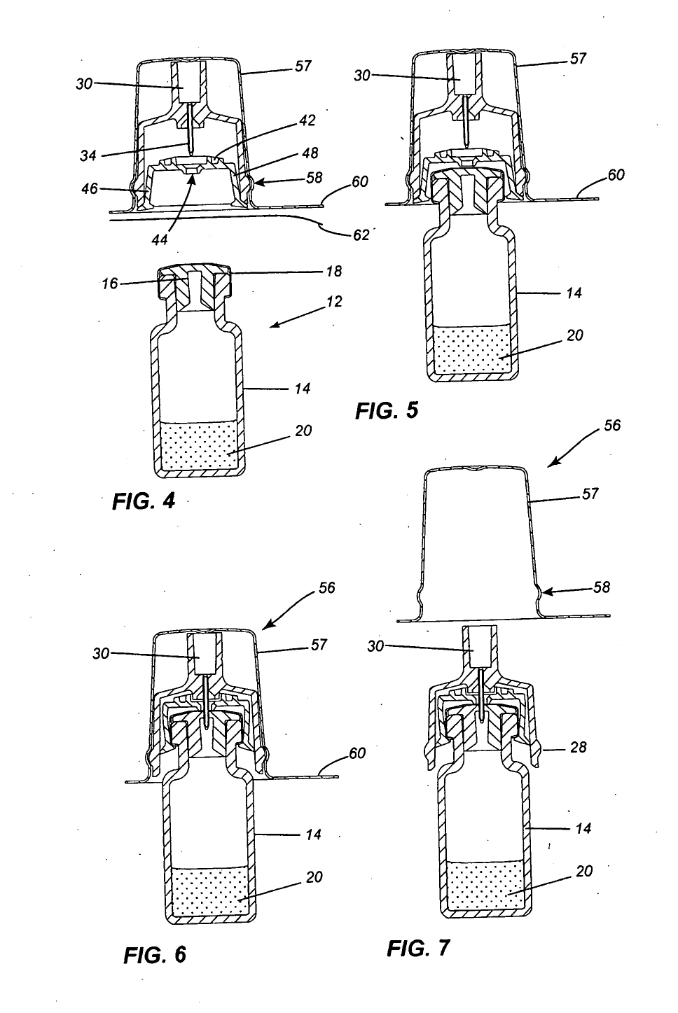

### DETAILED DESCRIPTION OF THE INVENTION

Referring to the drawings in greater detail and by reference characters thereto, there is illustrated a transfer system which is generally designated by reference numeral 10 and which is suitable for use with a vial generally designated by reference numeral 12.

Vial 12 has a body 14 with a neck sealed by a septum 16 over which there is a cap 18. A medicant 20 is contained within body 14 and would typically comprise a dry ingredient although a fluid may also be utilized.

Transfer system 10 includes an outer housing 24 and a circular side wall 26. On circular side wall 26 there is a protrusion 28 near the bottom thereof. On its upper end, there is provided a luer connection 30. An inner wall 32 mounts a needle 34 which is hollow in nature and has a piercing end 36. As previously mentioned, needle 34 may be a spike.

Mounted interiorly of outer housing 24 is a moveable member 40. Moveable member 40 has a top wall 42 with an aperture 44 centrally located therein to permit the passage of needle 34. Extending downwardly from top wall 42 is a first leg 46 and a second leg 48. First leg 46 has an outwardly extending flange 50 at the bottom thereof while second leg 48 also has an outwardly extending flange 52.

A cover 56 is provided to receive transfer system 10. Cover 56 has a side wall 57 which is adapted to engage with protrusion 28 to retain transfer system 10 in position. Side wall 57 is provided with an outwardly extending flange 60 at the bottom thereof. Flange 60 is designed to receive a peelable sealing strip 62 so as to provide a-hermetically sealed package.

The transfer system of the present invention is preferably utilized with a syringe which has a syringe body 66 and a plunger 68 mounted therein. A plunger rod 70 is designed to be screwthreadably engageable with plunger 68. Syringe body 66 includes a backstop 72 to permit proper gripping by the hand of a user. At its front end, syringe body 68 includes a luer connector 74. Typically, syringe body 66 is filled with a diluent 76 although any desired fluid may be utilized.

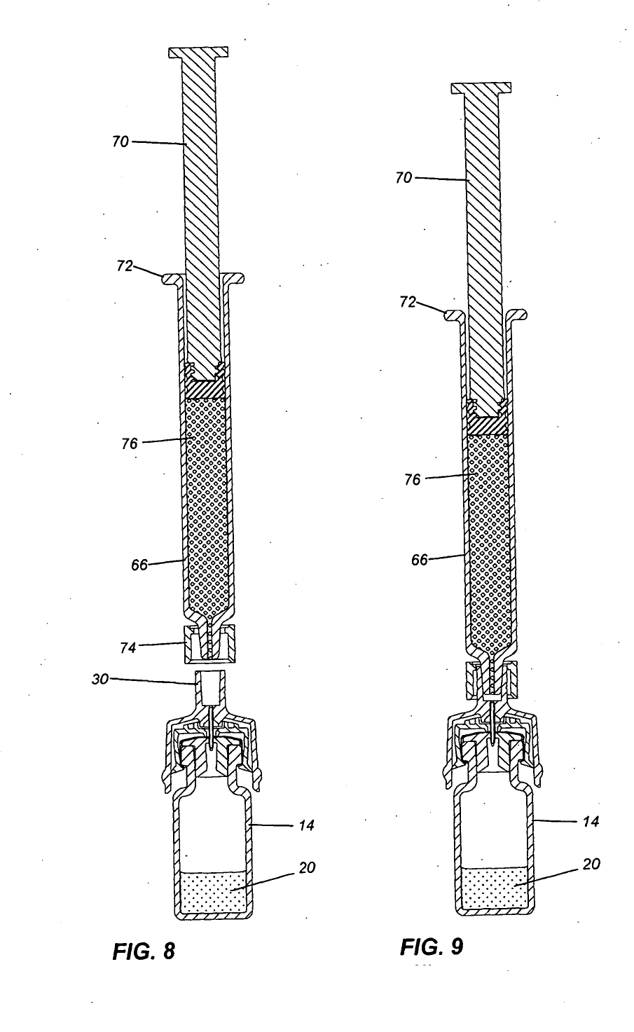

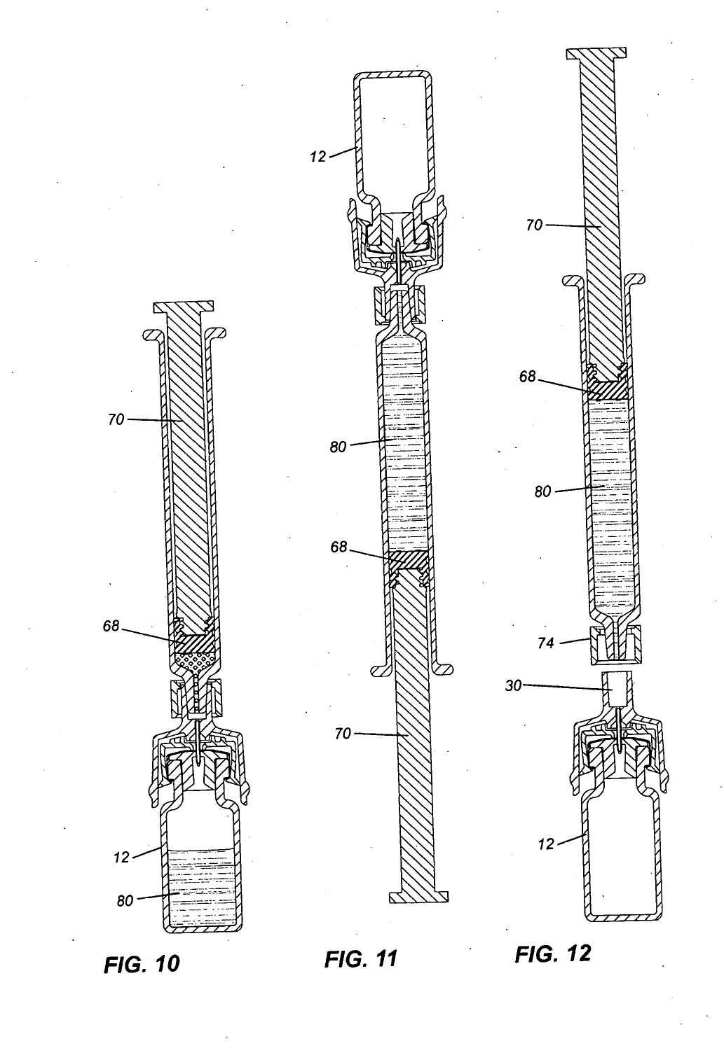

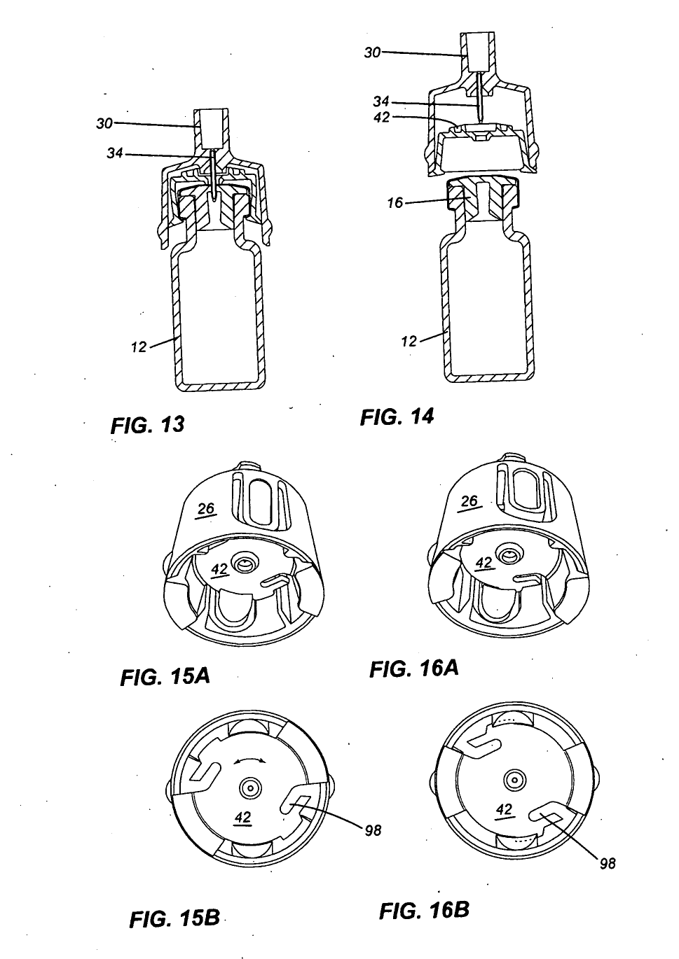

As shown in FIGS. 8 and 9, plunger rod 70 is connected to plunger 68 and the diluent 76 is then forced into vial body 14 as shown in FIG. 10. The medicant and diluent may then be mixed and the assembly inverted as shown in FIG. 11. The mixture 80 is then aspirated back into syringe body 66. The mixture 80 is then ready for injection when a needle assembly is connected to luer connector 74.

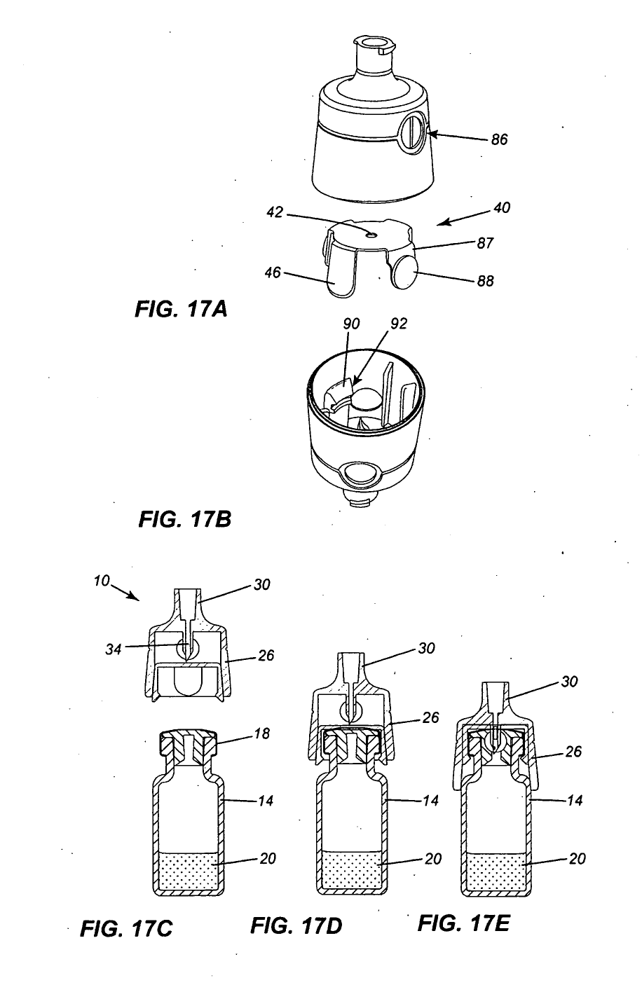

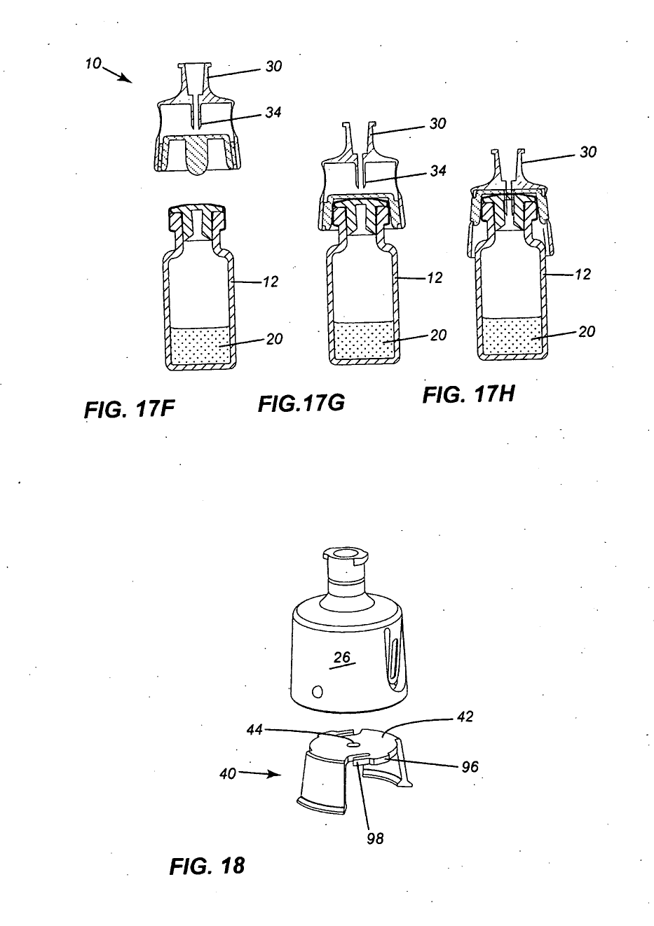

In the embodiment of FIGS. 17A to 17H, it will be noted that outer housing 24 is provided with a pair of apertures 86 in side wall 26. Also, in this embodiment, there are provided an extra pair of legs 87 each having buttons 88 formed on an exterior surface thereof. In this embodiment, when the moveable member 40 moves upwardly, buttons 88 engage in apertures 86.

On the interior surface of wall 26, there are provided ribs 90 which have a groove 92 formed therein. Thus, when pressure is exerted on buttons 86 as vial 12 is being withdrawn, moveable member 40 will move downwardly until the top wall 42 engages with groove 92. This retains moveable member 40 in position for further use.

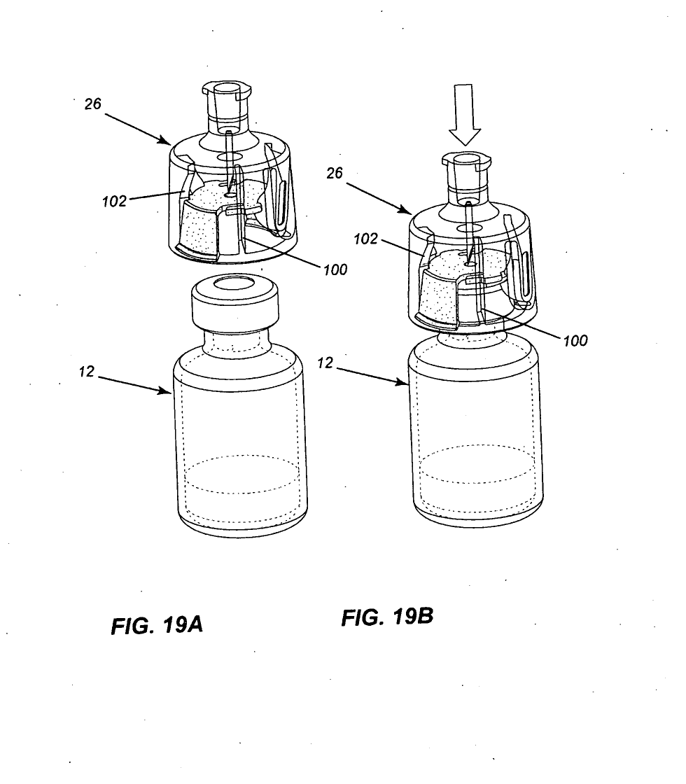

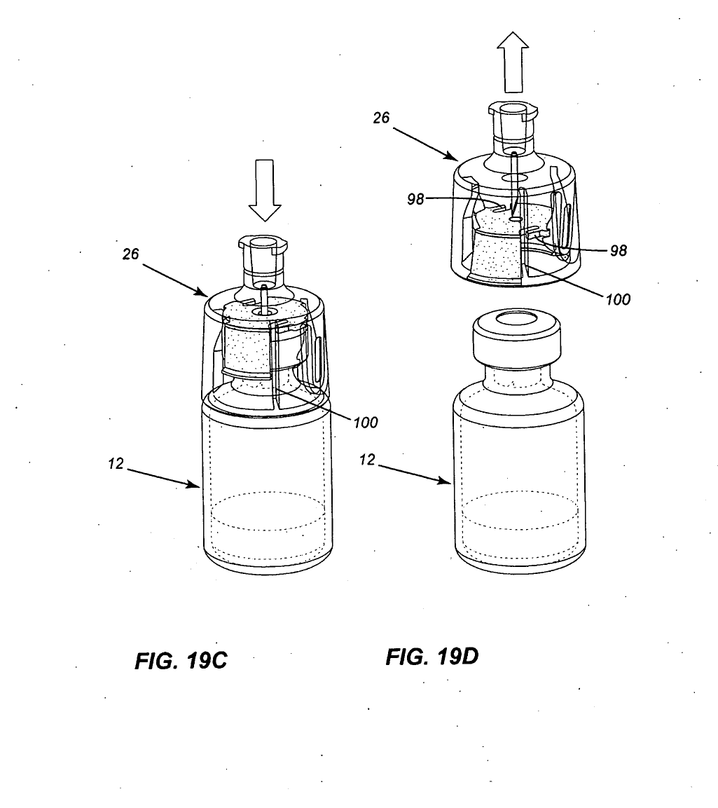

In the embodiment of FIGS. 18 to 19D, it will be noted that top wall 42 is provided with protrusions 96 and locking latches 98. On the interior there are provided ribs 100 and angled side wall portions 102. The arrangement is such that upon upward movement of moveable member 94, protrusions 96 engage with angled side wall 102 to rotate moveable member 40. Upon withdrawal, locking latches 98 engage with rib 100 so as to prevent further use of the transfer member.

We claim:

1. A transfer device comprising:
a housing (24) having a top, a side wall (26), an open bottom, said open bottom permitting insertion of a vial (12) within said housing;
a piercing member (34) mounted within said housing (24), said piercing member (34) having a piercing tip (36) located at a bottom end thereof, said piercing member having an interior passageway formed therein;
a connector (30) located on an exterior side of said top;
a moveable member (40) mounted within said housing (24), said moveable member (40) being moveable from a first position wherein said moveable member (40) prevents access to said piercing tip (36) and a second position permitting access to said piercing tip when said vial is inserted in said housing.

2. The transfer device of claim 1 wherein said moveable member (40) and said housing (24) cause said moveable member (40) to rotate when said moveable member (40) moves upwardly upon insertion of said vial (12), said moveable member returning to a third locked position upon removal of said vial, said third locked position being such that a further vial cannot be inserted into said housing.

3. The transfer device of claim 1 wherein said moveable member includes at least one leg (46), said housing having a recess formed therein, said leg engaging said recess when said moveable member is in said second position, said moveable member being returnable to said first position upon removal of said vial by pressure on said leg to release said leg from said recess.

4. The device of claim 2 wherein said piercing member is selected from the group consisting of a needle or spike.

5. The device of claim 4 wherein said moveable member (40) has a centrally located aperture (44) to permit said piercing member (34) to pass therethrough.

6. The device of claim 2 wherein said connector (30) on the exterior side of said top comprises a luer connector.

7. The device of claim 3 wherein said moveable member (40) has two projections, each projection being located on a respective one of diametrically opposite legs.

8. The device of claim 7 wherein said housing (24) has a recess formed on an interior surface thereof to receive a disc portion of said moveable member (40) when said moveable member is in said first position.
